(19) United States
(12) Patent Application Publication
(10) Pub. No.: US 2009/0198530 A1
(43) Pub. Date: Aug. 6, 2009

(54) AUTOMATED SOLUTION FOR MANAGING ANCILLARY WORKING RELATIONSHIPS IN AN ORGANIZATION

(75) Inventors: PATRICK J. O'SULLIVAN, BALLSBRIDGE (IE); HEMA SRIKANTH, CARY, NC (US); CAROL S. ZIMMET, BOXBOROUGH, MA (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/023,161

(22) Filed: Jan. 31, 2008

(51) Int. Cl. G06Q 10/00

(52) U.S. Cl. 705/7; 705/1

(57) ABSTRACT

The present invention discloses a method, system, device, and/or computer program for managing ancillary relationships in an organization. The invention can include a social network graph, a directory services data store, and an ancillary relationship coordinator. The social network graph can graphically illustrate the relationships, both direct and ancillary, between members of the organization. The directory services data store can be configured to contain a directory services tree corresponding to the social network graph. The ancillary relationship coordinator can be configured to automatically identify and manage the ancillary relationships between the members of the organization. The ancillary relationship coordinator can incorporate information pertaining to the ancillary relationships into the social network graph and the directory services data store.

### BACKGROUND OF THE INVENTION

The present invention relates to the field of organizational relationships and, more particularly, to an automated solution for managing ancillary working relationships in an organization.

The shift to a global business environment has had an impact on the organizational structure of businesses. In order to effectively utilize large and often geographically-separated personnel resources, many companies have adopted a matrix management approach. Matrix management is a management approach that groups personnel with similar skills together so they can be assigned to various project managers within the organization. For example, a group of marketing personnel can all report to the marketing manager as well as to the project managers and/or technical leads of the projects they are currently assigned to.

Although this approach is effective for managing personnel resources in a project-based environment, it is not without issues. The introduction of one or more managers that are outside of the conventional administrative relationship presents a challenge for documenting and disseminating such information.

These ancillary management relationships, often referred to as dotted-line relationships, are often short-lived and hidden from the rest of the organization. Such data repositories often rely upon manual updates, which often occur in an untimely manner. For example, corporate based directories often only contain an employee's direct, administrative manager without reference to any project managers or technical leads that they may report to for specific projects. This leads to confusion and miscommunication when attempting to contact ancillary managers for an employee.

Further, many of the existing personnel management tools do not support the use or tracking of ancillary relationships. Without tracking ancillary relationships, the tasks of budgeting and calculating project costs become a tedious, manual process. Under reporting of these relationships leads to inadequate estimates, cost overruns, and failures to meet deadlines.

### BRIEF SUMMARY OF THE INVENTION

One aspect of the present invention can include an automated system for managing ancillary relationships in an organization. Such a system can include a social network graph, a directory services data store, and an ancillary relationship coordinator. The social network graph can graphically present the relationships, both direct and ancillary, between members of the organization. The directory services data store can be configured to contain a directory services tree corresponding to the social network graph. The ancillary relationship coordinator can be configured to automatically identify and manage the ancillary relationships between the members of the organization. The ancillary relationship coordinator can incorporate information pertaining to the ancillary relationships into the social network graph and the directory services data store.

Another aspect of the present invention can include an automated method for identifying and managing ancillary relationships in an organization. Such a method can begin with the automatic capturing data for electronic collaboration interactions between members of an organization. The members of the organization can be described within a social network graph. This data can then be synthesized into a set of meta data about the members. The meta data can then be used to update the social network graph and entries for the directory services data store.

Still another aspect of the present invention can include a social networking system that automatically manages ancillary relationships in an organization. Such a social networking system can include online collaboration applications, a directory services data store, and an ancillary relationship coordinator. The directory services data store can contain a directory services tree that corresponds to a social network graph of the organization. The ancillary relationship coordinator can be configured to monitor the online collaboration applications to automatically identify ancillary relationships between members of the organization. Ancillary relationships can then be incorporated into the social network graph and the directory services data store.

### BRIEF DESCRIPTION OF THE SEVERAL VIEWS OF THE DRAWINGS

FIG. 1 is a schematic diagram of a system that identifies and manages ancillary relationships in an organization in accordance with an embodiment of the inventive arrangements disclosed herein.

FIG. 2 is a schematic diagram of an ancillary relationship coordinator that identifies and manages ancillary relationships within an organization in accordance with an embodiment of the inventive arrangements disclosed herein.

FIG. 3 is a flow chart of a method for identifying and managing ancillary relationships in an organization in accordance with an embodiment of the inventive arrangements disclosed herein.

### DETAILED DESCRIPTION OF THE INVENTION

The present invention discloses an automated solution for identifying and managing ancillary relationships in an organization. Ancillary relationships describe the relationships between members of an organization that exist outside of the conventional organizational structure. The automated solution can automatically capture data regarding the interaction of the members and synthesize the data to determine the existence of ancillary relationships between the members. Information pertaining to the ancillary relationships can then be used to update data repositories for sharing within the organization.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

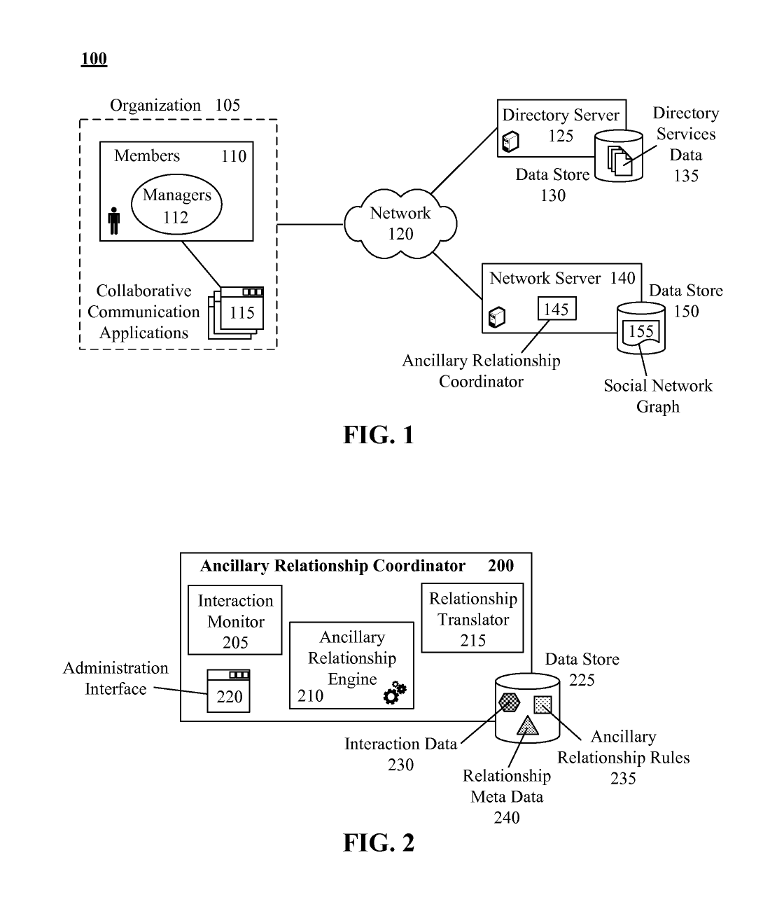

FIG. 1 is a schematic diagram of a system 100 that automatically identifies and manages ancillary relationships in an organization 105 in accordance with an embodiment of the inventive arrangements disclosed herein. In system 100, the ancillary relationship coordinator 145 can monitor interactions between members 110 that utilize collaborative communication applications 115 to determine the existence of ancillary relationships. Data relating to identified ancillary relationships can be used to update the organization's 105 social network graph 155 and corresponding enterprise directory data 135.

As used herein, an ancillary relationship describes a relationship between members of an organization that exist outside of the conventional organizational structure. For example, members of a group of engineers can be considered peers in a conventional organizational structure. An ancillary relationship can exist between the members of the group of engineers where one engineer is made a technical lead for a project that includes other engineers. The technical lead can be considered to be in a supervisory position for this project with the other engineers reporting to him, but the technical lead does not replace nor include the responsibilities of the administrative manager for the other engineers.

The organization 105 can represent an organized structure of members 110 who work together for a common goal, such as a corporation, a volunteer organization, and the like. Within the organization 105, there can exist members 110 who fulfill a supervisory role. Such members 110 can be labeled as managers 112. It should be noted that the term “manager” is used broadly herein to encompass the variety of supervisory positions within an organization 105, such as project managers, technical leads, functional managers, and the like, regardless of title.

The members 110 of the organization 105 can utilize a variety of collaborative communication applications 115 to facilitate and document business interactions. The collaborative communication applications 115 can represent a wide variety of applications, including, but not limited to, an email application, an instant messaging application, an online chat application, an online collaboration tool, an online document library application, an online calendar, an online meeting application, and the like. For example, a project team whose members 110 are located in various geographical offices can utilize an online collaboration tool and email to exchange ideas, data, and documents.

The ancillary relationship coordinator 145 can automatically monitor the interactions between members 110 over the network 120. That is, the ancillary relationship coordinator 145 can capture and process data regarding interactions without user intervention or interaction once it is configured to do so. Of particular note for the present invention are the interactions between managers 112 and other members 110. The ancillary relationship coordinator 145 can be a software application that can analyze monitored interactions between members 110 to determine if an ancillary relationship exists.

The ancillary relationship coordinator 145 can utilize a social network graph 155 of the members 110 as basis for determining relationships. For example, if Bob is already identified in the social network graph 155 as Mary's direct supervisor, then the ancillary relationship coordinator 145 can disregard the analysis of their interactions for an ancillary relationship.

The social network graph 155 can represent a variety of relationships between the members 110 of the organization 105. The social network graph 155 can convey information pertaining to ancillary relationships as well as a degree of strength of the relationship, depending on the implementation used by the organization 105. Thus, the social network graph 155 is not equivalent to a conventional organizational chart, although the social network graph 155 can include information traditionally included within an organizational chart.

In the social network graph 155, each member 110 can represent a node, which is connected to other nodes through a series of defined links, which define the relationship among the nodes. The social network graph 155 can be a semantic graph or a non-semantic graph. A graph can be considered semantic if the semantics of the graph are part of the graph or at least connected from the graph, otherwise a graph is considered non-semantic.

In one embodiment, the data store 150 containing the social network graph 155 can be remotely located from the network server 140 hosting the ancillary relationship coordinator 145. In such an embodiment, the remote location of the data store 150 can be accessible to the ancillary relationship coordinator 145 over the network 120.

When the ancillary relationship coordinator 145 identifies the existence of an ancillary relationship, the data pertaining to the ancillary relationship can be translated into the social network graph 155 as well as the entries for the specific members 110 contained within a set of directory services data 135.

The directory services data 135 can be contained within a data store 130 on a directory server 125 that is accessible to the ancillary relationship coordinator 145 over the network 120. The directory services data 135 can represent an organized set of data defining a variety of attributes about the members 110. For example, an online organizational telephone directory can be an implementation for directory services data 135.

The ancillary relationship coordinator 145 can add and/or modify attributes within the entries of the directory services data 135 that represent the identified ancillary relationship. Therefore, applications that access the directory services data 135 can also present the information regarding the ancillary relationship. For example, an organization directory can list a member's 110 direct manager as well as any additional project managers, project names, technical managers, and so on.

It should be noted that the automated nature of this system eliminates time delays that are often incurred in conventional, manual processes as well as the overall lack of capability of current systems to track information pertaining to ancillary relationships within an organization 105.

In another embodiment, the ancillary relationship coordinator 145 can interface over the network 120 with additional management applications (not shown) used by the organization 105, such as personnel and finance applications. By interfacing with such applications, key data can be shared to alleviate any need for redundant data entry. For example, the ancillary relationship coordinator 145 can “learn” the geographic location of members 110 from data contained in a personnel data base.

As used herein, presented data stores, including stores 130 and 150 can be a physical or virtual storage space configured to store digital information. Data stores 130 and 150 can be physically implemented within any type of hardware including, but not limited to, a magnetic disk, an optical disk, a semiconductor memory, a digitally encoded plastic memory, a holographic memory, or any other recording medium. Data stores 130 and 150 can be a stand-alone storage unit as well as a storage unit formed from a plurality of physical devices. Additionally, information can be stored within data stores 130 and 150 in a variety of manners. For example, information can be stored within a database structure or can be stored within one or more files of a file storage system, where each file may or may not be indexed for information searching purposes. Further, data stores 130 and/or 150 can utilize one or more encryption mechanisms to protect stored information from unauthorized access.

Network 120 can include any hardware/software/and firmware necessary to convey data encoded within carrier waves. Data can be contained within analog or digital signals and conveyed though data or voice channels. Network 120 can include local components and data pathways necessary for communications to be exchanged among computing device components and between integrated device components and peripheral devices. Network 120 can also include network equipment, such as routers, data lines, hubs, and intermediary servers which together form a data network, such as the Internet. Network 120 can also include circuit-based communication components and mobile communication components, such as telephony switches, modems, cellular communication towers, and the like. Network 120 can include line based and/or wireless communication pathways.

FIG. 2 is a schematic diagram of an ancillary relationship coordinator 200 that identifies and manages ancillary relationships within an organization in accordance with an embodiment of the inventive arrangements disclosed herein. The ancillary relationship coordinator 200 can be used within the context of system 100 or any other system supporting the automatic identification and management of ancillary relationships.

The ancillary relationship coordinator 200 can include an interaction monitor 205, an ancillary relationship engine 210, a relationship translator 215, an administration interface 220, and a set of ancillary relationship rules 235. The interaction monitor 205 can represent a software component configured to monitor the online interactions between members of the organization. The interaction monitor 205 can store a set of interaction data 230 within a data store 225 that contains pertinent information regarding monitored interactions.

The ancillary relationship engine 210 can include a software algorithm that synthesizes the captured interaction data 230 to produce a set of relationship meta data 240. The ancillary relationship engine 210 can utilize the ancillary relationship rules 235 during synthesis. The ancillary relationship rules 235 can represent a set of conditions that are to be met to determine the existence of an ancillary relationship between organization members. For example, an ancillary relationship rule 235 can define that the member in the supervisory position cannot be junior to the other member. That is, interactions between a junior engineer and a mid-level engineer should not create an ancillary relationship with the junior engineer in the supervisory position.

The set of relationship meta data 240 can be produced and/or can be utilized by the ancillary relationship engine 210. Relationship meta data 240 (i.e., data about data) can refer to any digitally encode-able information able to be associated with a relationship. Relationship meta data 240 adds context and additional information to data object, which itself represents a relationship, a set of relationships, or an aspect of a relationship. Hence, the relationship meta data 240 can represent the specific data attributes describing the ancillary relationship. Examples of such data attributes can include the organizational distance between the identified members, the degree of interaction between the identified members, an indication of a management position, the relationship strength, and the like.

The relationship translator 215 can be a software component that utilizes the relationship meta data 240 to update various organization data repositories, such as the social network graph 155 and directory services data 135 of system 100. The relationship translator 215 can include the algorithms necessary to propagate such modifications to the target data repositories.

The administration interface 220 can be the means by which an administrator can configure the components and function of the ancillary relationship coordinator 200. The administration interface 220 can be configured to perform a variety of tasks, including, but not limited to, defining ancillary relationship rules 235, selecting interaction types to monitor, establishing a frequency at which the ancillary relationship engine 210 should synthesize the interaction data 230, defining the target data repositories for updating, and the like.

As used herein, presented data stores, including store 225 can be a physical or virtual storage space configured to store digital information. Data store 225 can be physically implemented within any type of hardware including, but not limited to, a magnetic disk, an optical disk, a semiconductor memory, a digitally encoded plastic memory, a holographic memory, or any other recording medium. Data store 225 can be a stand-alone storage unit as well as a storage unit formed from a plurality of physical devices. Additionally, information can be stored within data store 225 in a variety of manners. For example, information can be stored within a database structure or can be stored within one or more files of a file storage system, where each file may or may not be indexed for information searching purposes. Further, data store 225 can utilize one or more encryption mechanisms to protect stored information from unauthorized access.

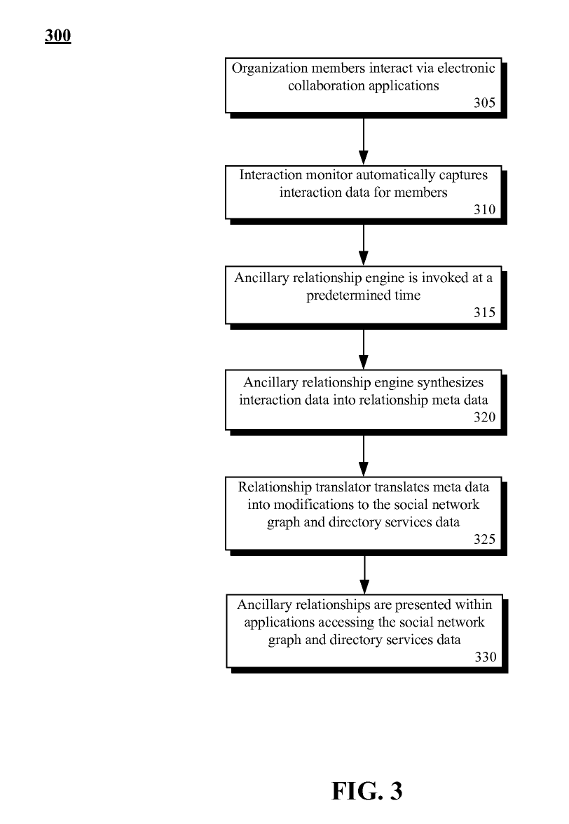

FIG. 3 is a flow chart of a method 300 for automatically identifying and managing ancillary relationships in an organization in accordance with an embodiment of the inventive arrangements disclosed herein. Method 300 can be performed within the context of system 100 and/or using the ancillary relationship coordinator 200 of FIG. 2, or any other system supporting the automatic identification and management of ancillary relationships.

Method 300 can begin with step 305 where organization members can interact using electronic collaboration applications. The interaction monitor can automatically capture interaction data for the members in step 310. In step 315, the ancillary relationship engine can be invoked at a predetermined time. For example, the ancillary relationship engine can be configured to execute on a daily, weekly, and/or monthly basis.

The ancillary relationship engine can synthesize the interaction data into relationship meta data in step 320. In step 325, the relationship translator can translate the meta data into modifications to the social network graph and directory services data. The ancillary relationships can be presented within applications accessing the social network graph and directory services tree in step 330.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An automated system for managing ancillary relationships in an organization comprising:
a social network graph configured to graphically illustrate a plurality of relationships between members of an organization, wherein a classification of a relationship within the plurality of relationships comprises at least direct and ancillary relationships;
a directory services data store configured to contain at least one directory services tree representing information illustrated in the social network graph, wherein the at least one directory services tree stores the plurality of relationships of the social network graph in a standardized format; and
an ancillary relationship coordinator configured to automatically identify and manage a plurality of ancillary relationships between members of the organization, wherein the plurality of ancillary relationships are incorporated into the social network graph and the at least one directory services tree.

2. The system of claim 1, wherein the ancillary relationship coordinator further comprises:
an interaction monitor configured to automatically capture occurrences of interaction events between the members of the organization;
a set of ancillary relationship rules defining conditions for an existence of an ancillary relationship;
an ancillary relationship engine monitor configured to determine an existence of an ancillary relationship based on the set of ancillary relationship rules and data captured by the interaction monitor, wherein a set of meta data is produced for the ancillary relationship; and
a relationship translator monitor configured to translate the meta data produced by the ancillary relationship engine into formats for incorporation into the social network graph and the directory services data store.

3. The system of claim 2, further comprising:
an administration interface configured to allow user-configuration of at least one of the ancillary relationship engine, the interaction monitor, the set of ancillary relationship rules, and the relationship translator.

4. The system of claim 2, wherein the occurrences of interaction events comprises at least one of a physical meeting scheduled in an electronic calendar, an online meeting, an online chat session, a session in an online collaboration tool, a use of a document library, a teleconference, and an email message.

5. The system of claim 2, wherein the set of meta data defines at least one attribute describing the ancillary relationship, wherein the at least one attribute comprises one of a name of the member of the organization fulfilling a supervisory role, a name of the member of the organization fulfilling a subordinate role, a degree of interaction between the member of the organization fulfilling the supervisory role and the member of the organization fulfilling the subordinate role, an identifier of a supervisory position, and an organizational distance between the member of the organization fulfilling the supervisory role and the member of the organization fulfilling the subordinate role.

6. The system of claim 1, wherein the ancillary relationship coordinator is configured to execute at a predetermined time interval.

7. The system of claim 1, wherein the ancillary relationship coordinator is written as a component of a service-oriented architecture (SOA).

8. The system of claim 1, wherein an incorporation of the set of meta data into the directory services data store utilizes a Lightweight Directory Access Protocol (LDAP) compliant protocol, wherein the at least one directory tree is a LDAP compliant tree.

9. The system of claim 1, wherein the ancillary relationship coordinator interfaces with at least one personnel application in order to access additional organizational data regarding the members of the organization.

10. A method for managing ancillary relationships in an organization comprising:
automatically and dynamically capturing data for a plurality of electronic collaboration interactions between members of an organization, wherein the members of the organization are described within a social network graph;
synthesizing the data for the plurality of electronic collaboration interactions into a set of meta data about the members; and
updating the social network graph and entries in a directory services data store to reflect the set of meta data, wherein the directory services data store contains an entry corresponding to each member of the social network graph.

11. The method of claim 10, wherein the plurality of electronic collaboration interactions comprises at least one of a meeting scheduled in an electronic calendar, an online meeting, an online chat session, a session in an online collaboration tool, a use of a document library, a teleconference, and an email message.

12. The method of claim 10, wherein synthesizing the data for the plurality of electronic collaboration interactions into a set of meta data about the members further comprises:
extracting at least one key data element from each electronic collaboration interaction, wherein the at least one key element is an attribute that describes a relativity between the members of the organization;
applying a set of ancillary relationship rules to the at least key data element to determine an existence of an ancillary relationship between the members; and
generating the set of meta data for the members, wherein the set of meta data contains at least one attribute describing the ancillary relationship.

13. The method of claim 12, wherein the at least one attribute of the set of meta data comprises one of a name of the member of the organization fulfilling a supervisory role, a name of the member of the organization fulfilling a subordinate role, a degree of interaction between the member of the organization fulfilling the supervisory role and the member of the organization fulfilling the subordinate role, an identifier of a supervisory position, and an organizational distance between the member of the organization fulfilling the supervisory role and the member of the organization fulfilling the subordinate role.

14. The method of claim 12, wherein the set of ancillary relationship rules defines at least one condition for the existence of the ancillary relationship, wherein the at least one condition comprises one of an organizational distance threshold, an interaction frequency threshold, a geographical distance threshold, an internal grouping requirement, and a degree of interaction threshold.

15. The method of claim 10, wherein the ancillary relationship coordinator interfaces with at least one personnel application in order to access additional organizational data regarding the members of the organization.

16. A computer program product for managing ancillary relationships in an organization, the computer program product comprising:
a computer usable medium having computer usable program code embodied therewith, the computer usable program code comprising:
computer usable program code configured to automatically and dynamically capture data for a plurality of electronic collaboration interactions between members of an organization, wherein the members of the organization are described within a social network graph;
computer usable program code configured to synthesize the data for the plurality of electronic collaboration interactions into a set of meta data about the members; and
computer usable program code configured to update the social network graph and entries in a directory services data store to reflect the set of meta data, wherein the directory services data store contains an entry corresponding to each member of the social network graph.

17. The computer program product of claim 16, wherein the plurality of electronic collaboration interactions includes at least one of a meeting scheduled in an electronic calendar, an online meeting, an online chat session, a session in an online collaboration tool, a use of a document library, a teleconference, and an email message.

18. The computer program product of claim 16, wherein the computer usable program code further comprises:
computer usable program code configured to extract at least one key data element from each electronic collaboration interaction, wherein the at least one key element is an attribute that describes a relativity between the members of the organization;
computer usable program code configured to apply a set of ancillary relationship rules to the at least key data element to determine an existence of an ancillary relationship between the members; and
computer usable program code configured to generate the set of meta data for the members, wherein the set of meta data contains at least one attribute describing the ancillary relationship.

19. The computer program product of claim 18, wherein the at least one attribute of the set of meta data includes one of a name of the member of the organization fulfilling a supervisory role, a name of the member of the organization fulfilling a subordinate role, a degree of interaction between the member of the organization fulfilling the supervisory role and the member of the organization fulfilling the subordinate role, an identifier of a supervisory position, and an organizational distance between the member of the organization fulfilling the supervisory role and the member of the organization fulfilling the subordinate role.
